(19) United States
(12) Patent Application Publication
(10) Pub. No.: US 2003/0019427 A1
(43) Pub. Date: Jan. 30, 2003

(54) In situ stabilized high concentration BPSG films for PMD application

(75) Inventors: Steve Ghanayem, Los Altos, CA (US); Daniel A. Carl, Pleasanton, CA (US); John T. Boland, Scotts Valley, CA (US); Cary Ching, Sunnyvale, CA (US); Zheng Yuan, Fremont, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/912,495

(22) Filed: Jul. 24, 2001

(51) Int. Cl. B05C 11/00

(52) U.S. Cl. 118/712; 156/345.24

(57) ABSTRACT

A method and apparatus for forming an in situ stabilized high concentration borophosphosilicate glass film on a semiconductor wafer or substrate. In an embodiment, the method starts by providing the substrate into a chamber. The method continues by providing a silicon source, an oxygen source, a boron source and a phosphorous source into the chamber to form a high concentration borophosphosilicate glass layer on the substrate. The method further includes reflowing the high concentration borophosphosilicate glass layer formed on the substrate.

### BACKGROUND OF THE INVENTION

1. Field of the Invention

The present invention relates generally to the field of substrate processing for semiconductor manufacturing and more specifically to an improved method and apparatus for forming in situ stabilized high concentration borophosphosilicate glass (BPSG) films on a semiconductor wafer.

2. Description of Related Art

Silicon oxide (SiO₂) is widely used as an insulating layer in the manufacture of semiconductor devices. A silicon oxide film is generally deposited by thermal chemical vapor deposition (CVD) or plasma enhanced chemical vapor deposition (PECVD) processes from a reaction of an oxygen-containing source such as ozone (O₃) or oxygen (O₂), with a silicon-containing source. In general, reaction rates in thermal and plasma CVD processes may be controlled by controlling one or more of the following: temperature, pressure, reactant gas flow rate, and RF power.

One particular use for a silicon oxide film is as a separation layer between the polysilicon gate level and the first metal level of metal oxide (MOS) transistors. Such separation layers are referred to as premetal dielectric (PMD) layers because they are typically deposited before any of the metal levels in a multilevel metal structure. In addition to having a low stress and low contamination, it is important for PMD layers to have good planarization and gap-fill characteristics.

When used as a PMD layer, the silicon oxide film is deposited over a silicon substrate having a lower level polysilicon gate/interconnect layer. The surface of the silicon substrate may include isolation structures, such as gaps or trenches, and raised or stepped surfaces, such as polysilicon gates and interconnects. The initially deposited film generally conforms to the topography of the substrate surface and is typically planarized or flattened and goes through lithography steps before an overlying metal layer is deposited.

As semiconductor design has advanced, the feature size of the semiconductor devices has dramatically decreased. Many integrated circuits now have features, such as trenches that are less than half-micron across. Manufacturing submicron devices poses a number of challenges, including for example the ability to completely fill a narrow gap/trench in a void-free manner. If the trench is wide and shallow, it is relatively easy to completely fill the trench with silicon oxide glass. As the trench gets narrower and the aspect ratio (the ratio of the trench height to the trench width) increases, it becomes more likely that a void will be formed within the gap/trench. Under certain conditions, the void can be filled during a glass reflow process; however, as the trench becomes narrower or the thermal budget allowed for glass reflow is reduced, it becomes more likely that the void will not be filled during the reflow process at the low temperature. Such voids are undesirable as they can reduce the yield of good chips per wafer and the reliability of the devices.

For a number of years, boron and phosphorous doped silicate films, such as borophosphosilicate glass (BPSG) films, deposited with liquid sources such as tetraethylorthosilicate (TEOS) have gained preference among silicon oxide films for their superior gap filling capability upon glass reflow. Furthermore, BPSG films have found particular applicability in applications that employ a glass reflow step to planarize PMD layers. Such doped oxide glass layers lower the glass transition temperature of the glass layer and permit the layers to soften and reflow, thus smoothing the underlying topography.

Prior art doped oxide glass film deposition and/or reflow processes, however, have a number of limitations including, for example, having to perform the film deposition and/or reflow at relatively high temperatures of about 800-900° C., to attempt to fully fill the gaps or voids in the substrate of submicron semiconductor devices. Another limitation of prior art doped oxide glass film deposition and/or reflow processes is keeping the dopant concentrations of boron and phosphorous at low levels to avoid surface crystallite defects and hygroscopicity when film is exposed to moisture. Another further limitation of prior art doped oxide glass film deposition and/or reflow processes is that these processes typically require the deposition of a capping layer of undoped silicon glass (USG) film (or lightly doped boron and phosphorous glass film) over the bulk doped silicon glass film to prevent moisture present in the ambient from being absorbed and penetrate into the doped silicon glass film before films densified upon anneal or reflow.

Another manufacturing challenge presented by submicron devices is minimizing the overall thermal budget of the integrated circuit fabrication process in order to maintain shallow junctions and prevent the degradation of metal contact structures among other reasons. One way to reduce the overall thermal budget of a fabrication process is to reduce the reflow temperature of the BPSG premetal dielectric layer to below about 750° C. However, for submicron semiconductor devices, such as highly dense dynamic random access memory (DRAM) devices or logic memory devices, which have trenches with high aspect ratios (e.g., over about 6:1), reducing the reflow temperature of the BPSG layer without making any changes to the current glass deposition and/or reflow process would likely not be sufficient to completely fill in a narrow trench in a void-free manner.

### SUMMARY OF THE INVENTION

A method and apparatus for forming an in situ stabilized high concentration borophosphosilicate glass film on a semiconductor wafer or substrate is described. In an embodiment, the method starts by providing the substrate into a chamber. The method continues by providing a silicon source, an oxygen source, a boron source and a phosphorous source into the chamber to form a high concentration borophosphosilicate glass layer on the substrate. The method further includes reflowing the high concentration borophosphosilicate glass layer formed on the substrate.

### BRIEF DESCRIPTION OF THE DRAWINGS

The present invention is illustrated by way of example and not limitation in the accompanying figures:

FIG. 1A schematically illustrates a diagram of an exemplary multichamber system 10 for forming in situ stabilized high concentration borophosphosilicate glass (BPSG) films on a semiconductor substrate or wafer according to an embodiment of the present invention.

FIG. 1B illustrates an exemplary embodiment of a chamber for depositing a doped silicon oxide layer on a substrate in the multichamber system of FIG. 1A.

FIG. 1C illustrates an exemplary embodiment of a chamber for rapid thermal processing reflow of a substrate following silicon oxide layer deposition in the multichamber system of FIG. 1A.

FIG. 2 illustrates an example embodiment of a hierarchy of a system control computer program stored in memory of a system controller of multichamber system of FIG. 1A.

FIG. 3 outlines an embodiment of a method for forming in situ stabilized high concentration borophosphosilicate glass films on a semiconductor wafer according to the present invention.

FIG. 4A is a simplified, cross-sectional view of a substrate following BPSG film deposition.

FIG. 4B is a simplified, cross-sectional view of a substrate with the BPSG film deposited thereon following the reflow step according to method of FIG. 3.

### DETAILED DESCRIPTION OF THE INVENTION

An improved method and apparatus for forming in situ stabilized high concentration borophosphosilicate glass (BPSG) films on a substrate or semiconductor wafer are described. In the following detailed description, numerous specific details are set forth in order to provide a more thorough understanding of the present invention. However, it will be apparent to those skilled in the art to which this invention pertains that the present invention may be practiced without these specific details. In other instances, well-known devices, methods, procedures, and individual components have not been described in detail so as not to unnecessarily obscure aspects of the present invention.

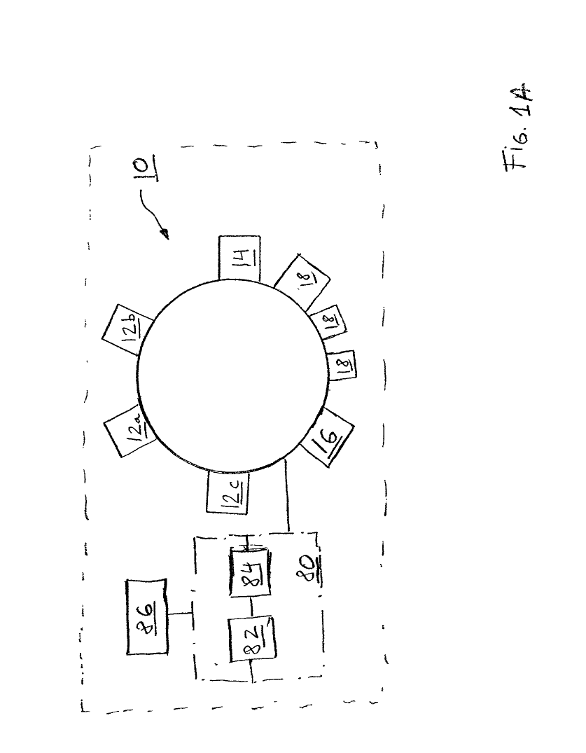

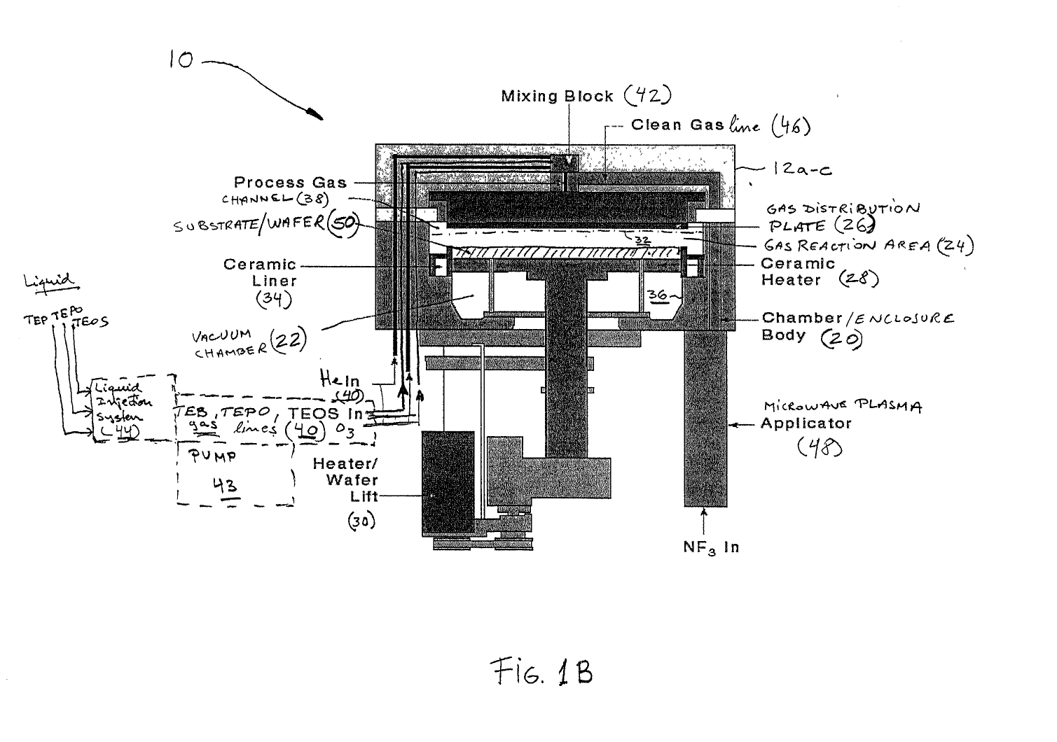

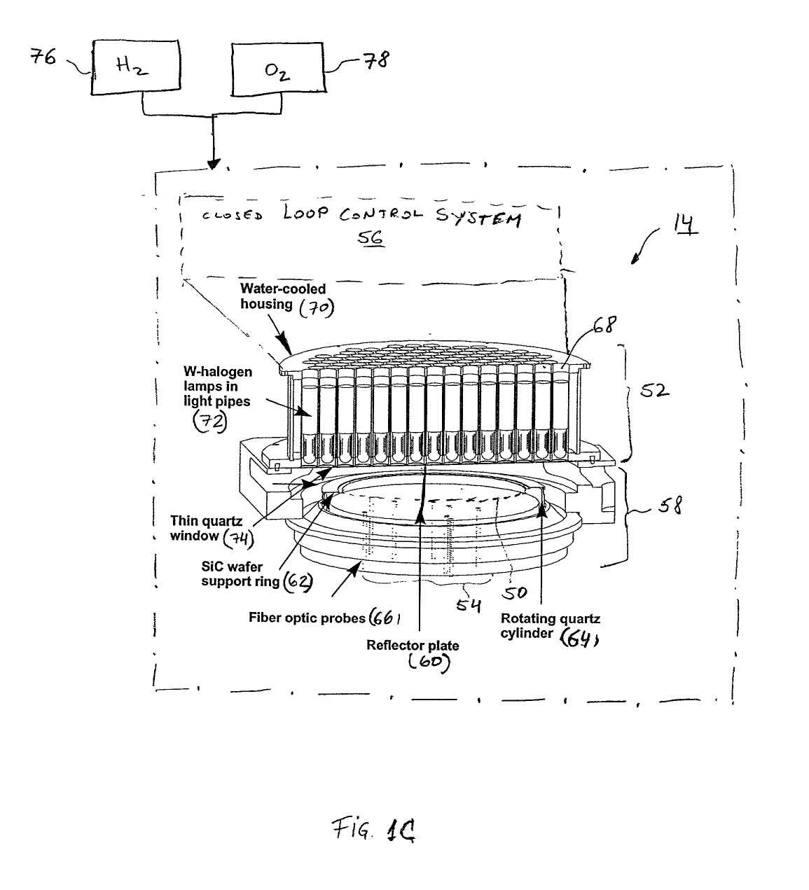

FIG. 1A schematically illustrates a diagram of an exemplary substrate processing system, such as multichamber system 10 for forming in situ stabilized high concentration borophosphosilicate glass (BPSG) films on a semiconductor substrate or wafer according to an embodiment of the present invention. The multichamber system 10, also known as a cluster tool, has the capability to process a plurality of substrates between its chambers without breaking vacuum and without having to expose the wafers to moisture or other contaminants outside the multichamber system 10. An advantage of the multichamber system 10 is that different chambers 12a-c, 14, 16, 18 in the multichamber system 10 may be used for different purposes in the entire process. For example, chambers 12a, 12b, 12c may each be used for deposition of doped boron phosphorous silicon oxides on a semiconductor wafer/substrate, chamber 14 may be used for rapid thermal processing (RTP), e.g. reflow, following deposition of doped silicon oxide film on substrate, and yet another chamber 16 may be used as a substrate cooldown chamber following RTP. Other chambers 18 may serve other purposes within the process, for example as an auxiliary chamber, e.g., loading/unloading substrate into multi-chamber system 10. The process may proceed uninterrupted within the multichamber system 10, thus preventing contamination of wafers that often occurs when transferring wafers between various separate individual chambers (not in a multichamber system) for different parts of a process. Performing the deposition and heating steps in the same multichamber system 10 provides better control of the thickness, uniformity, and moisture content of the doped dielectric film.

Continuing with reference to FIG. 1A, a system controller 80 controls all of the activities of the substrate processing system, e.g. multichamber CVD system 10. In an embodiment of the present invention the system controller 80 includes a hard disk drive (memory 82), a floppy disk drive and a processor 84. The processor 84 contains a single board computer (SBC), analog and digital input/output boards, interface boards and stepper motor controller board. Various parts of CVD system 10 conform to the Versa Modular European (VME) standards which define board, card cage, and connector dimensions and types. The VME standard also defines the bus structure having a 16-bit data bus and 2-bit address bus.

System controller 80 executes system control software, which is a computer program stored in a computer-readable medium such as a memory 82. Preferably, memory 82 is a hard disk drive, but memory 82 may also be other kinds of memory. The computer program includes sets of instructions that dictate the timing, mixture of gases, chamber pressure, chamber temperature, lamp power levels, susceptor position, and other parameters of a particular process. Of course, other computer programs such as one stored on another memory device including, for example, a floppy disk or other another appropriate drive, may also be used to operate controller 80. An input/output device 86 such as a CRT monitor and a keyboard is used to interface between a user and controller 80.

FIGS. 1B and 1C illustrate exemplary embodiments of chambers 12a-c, 14, 16, and 18 in the multichamber system 10 used in substrate processing. Specifically, FIG. 1B depicts a chamber for depositing a doped silicon oxide layer on a substrate, while FIG. 1C illustrates a chamber for rapid thermal processing (RTP) of a substrate following silicon oxide layer deposition. The two chambers are discussed in detail below.

It should be noted that the configuration, arrangement, hardware elements, etc. of multichamber system 10, and thus chambers 12a-c, 14, 16, 18 shown in FIGS. 1B and 1C may vary depending on a number of considerations, included but not limited to, specific sub-atmospheric chemical vapor deposition (SACVD) process implemented, substrate process specifications set by semiconductor manufacture clients, technological advances/optimizations, etc. Therefore, not all chamber hardware elements illustrated in FIGS. 1B and 1C may be included in every chamber 12a-c, 14, 16, and 18 in the multichamber system 10.

FIG. 1B is an exemplary representation of a deposition chamber 12a-c in the multichamber system 10. Referring to FIG. 1B, a deposition chamber 12a-c in the multichamber system 10 includes an enclosure assembly 20 housing a vacuum chamber 22 with a gas reaction area 24. A gas distribution plate 26 having perforated holes is provided above the gas reaction area 24 for dispersing reactive gases through perforated holes in plate 26 to a semiconductor wafer or substrate 50 that rests on a vertically movable heater 28 (also referred to as a wafer support pedestal or susceptor). Multichamber system 10 further includes a heater/lift assembly 30 for heating the wafer 50 supported on heater 28. Heater/lift assembly 30 can be controllably moved between a lower loading/off-loading position and an upper processing position indicated by dotted line 32 which is closely adjacent to plate 26, as shown in FIG. 1B. A center board (not shown) includes sensors for providing information on the position of the wafer 50. Heater 28 includes resistively-heated components enclosed in a ceramic, such as aluminum nitride. When heater 28 and the wafer 50 are in processing position 32, they are surrounded by a chamber liner 34 along the inside walls 36 of multichamber system 10 and by an annular pumping channel 38, formed by chamber liner 34 and a top portion of chamber 22. The surface of chamber liner 34 serves to lower the temperature gradient between resistively-heated heater 28 (high temperature) and chamber walls 38, which are at a much lower temperature relative to heater 28.

Reaction and carrier gases are supplied through supply lines 40 into a gas mixing block (or gas mixing box) 42, where they are preferably mixed together and delivered to plate 26. In a preferred embodiment, reaction sources are liquids which are first vaporized by a liquid injection system 44 and then combined with an inert carrier gas such as helium. Gas mixing block 42 may be a dual input mixing block coupled to a process gas supply line 40 and to a cleaning gas conduit 46. At least one pump 43 coupled to the gas outlet is typically used to control the chamber pressure (and thus the injection of gases into the chamber). System controller 80 controls the operation of a valve (not shown) to choose which of these two alternate sources of gases are sent to plate 26 for dispersing into vacuum chamber 22. Conduit 46 receives clean gases from an integral remote plasma system 48. During deposition processing, gas supplied to plate 26 is vented toward the surface of the wafer 50 where it may be uniformly distributed radially across the wafer surface, typically in a laminar flow. Purging gas may be delivered into chamber 22 from an inlet port or tube (not shown) through the bottom wall of enclosure assembly 20. It should be noted that integral remote plasma system 48 may be used for periodic chamber cleaning, wafer cleaning, or depositing steps.

Turning to FIG. 1C, an embodiment of a chamber 14 for rapid thermal processing (RTP) of a wafer following dielectric film deposition that is part of multichamber system 10 is illustrated. The RTP chamber embodiment 14 described below generally includes four main components. The first component consists of a radiant heat source or lamp head 52. The second and third components are made up of the temperature measurement system 54 and the closed loop control system 56 which drives the lamp head 52. The fourth component is the wafer process chamber 58. A highly reflective coating is applied to the chamber bottom plate 60 using materials compatible with semiconductor processing. It will be noted that FIG. 1C details the RTP wafer process chamber 58, the lamp head 52, and portions of the temperature measurement system 54.

Provisions for gas handling, low pressure operation and wafer exchange are provided in the RTP wafer process chamber 58. Wafers 50 (shown as dashed line) are supported in the chamber 58 by a silicon carbide support ring 62 that contacts only the outer edge of the wafer 50. The ring is mounted on a quartz cylinder 64 that extends into the chamber bottom where it is supported by a bearing (not shown). The bearing is magnetically coupled to an external motor (not shown) that is used to rotate the wafer 50 and assembly (i.e., ring, quartz cylinder, etc.). Temperature measurement probes connected to fiber optics 66 are mounted in the chamber bottom as shown in FIG. 1C. The architecture of this RTP chamber system provides flexibility to modify the chamber materials and design to accommodate process requirements and wafer types while the design of the radiant heat source and temperature measurement and control system remain essentially unchanged. A detailed description of these components follows.

The lamp head 52 is made of a honeycomb of tubes 68 in a water jacket housing or assembly 70. Each tube 68 contains a reflector and a tungsten halogen lamp assembly which forms a honeycomb light pipe arrangement 72. This close packed hexagonal arrangement of collimating light pipes provides the radiant energy sources with high power density with good spatial resolution of the lamp outputs. Wafer rotation is used to smooth lamp to lamp variations thus eliminating the need to match lamp performance.

Continuing with reference to FIG. 1C, a quartz window 74 separates the lamp head 52 from the chamber 58. Typically, a thin window of about 4 millimeters (mm) is used which reduces the “thermal memory” by minimizing the absorbing thermal mass. The window 74 is cooled by contact with the lamp head 52. For reduced pressure operation, window 74 may be replaced by an adapter plate (not shown).

An important aspect of the lamp head 52 design for reliable wafer processing in a manufacturing environment is the robustness as a radiant heat source. The lamp head system 52 is designed with sufficient reserve so that the lamps 72 can be operated well below their rated values. The use of a large number of lamps in this design (an embodiment typically has 187 lamps for 200 mm wafer size) results in a lamp redundancy. If a lamp fails during operation in any one zone, the multi-point closed loop control will maintain the temperature set points. The use of wafer rotation averages out local intensity variations that may occur such that no degradation of process performance will occur.

Rapid thermal processing of the deposited BPSG film layer may be performed in a dry (e.g., N₂ or O₂) ambient, a wet (e.g., steam, H₂O) ambient, a wet ambient formed by in-situ reaction of H₂ and O₂, or a combination thereof (ex-situ). As indicated in FIG. 1C, in an embodiment, a hydrogen supply 76 and an oxygen supply 78 are coupled to the RTP chamber 14.

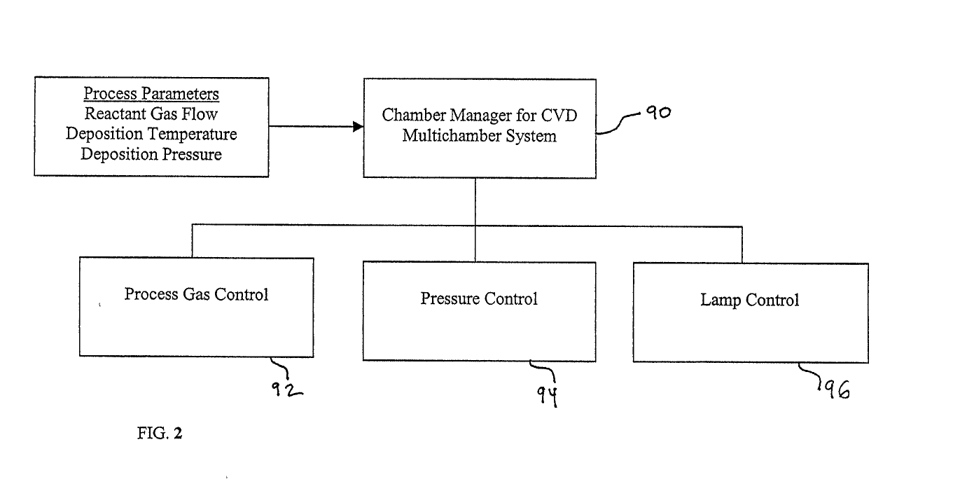

With reference to FIGS. 1A and 2, the multichamber system 10 further includes a system controller 80 that controls all of the activities of the multichamber CVD system. In an embodiment of the present invention the system controller 80 includes a hard disk drive (memory 82), a floppy disk drive and a processor 84. An input/output device 86 such as a CRT monitor and a keyboard is used to interface between a user and controller 80.

System controller 80 executes system control software, which is a computer program stored in a computer-readable medium such as a memory 82. Preferably, memory 82 is a hard disk drive, but memory 82 may also be other kinds of memory. The computer program includes sets of instructions that dictate the timing, mixture of gases, chamber pressure, chamber temperature, lamp power levels, susceptor position, and other parameters of a particular process. Of course, other computer programs such as one stored on another memory device including, for example, a floppy disk or another appropriate drive, may also be used to operate controller 80.

The process for depositing and reflowing (i.e., annealing) the highly doped BPSG film can be implemented using a computer program product which is stored in memory 82 and is executed by controller 80. The computer program code can be written in any conventional computer readable programming language, such as, 68000 assembly language, C, C ++, Pascal, Fortran, or others. Suitable program code is entered into a single file, or multiple files, using a conventional text editor, and stored or embodied in a computer usable medium, such as a memory system of the computer. If the entered code text is in a high level language, the code is compiled, and the resultant complier code is then linked with an object code of precompiled windows library routines. To execute the linked compiled object code, the system user invokes the object code, causing the computer system to load the code in memory, from which the CPU reads and executes the code to perform the tasks identified in the program. Also stored in memory 82 are process parameters such as reactant gas flow rates and composition, temperatures and pressure necessary to carry out the deposition and reflow of an in situ boron-phosphorous doped amorphous or polycrystalline silicon film in accordance with the present invention.

FIG. 2 illustrates an example embodiment of a hierarchy of a system control computer program stored in memory 82 of a system controller 80 of multichamber system of FIG. 1A. The system control program includes a chamber manager subroutine 90. The chamber manager subroutine 90 also controls execution of various chamber component subroutines which control the operation of the chamber components necessary to carry out the selected process set. Examples of chamber component subroutines are process reactant gas control subroutine 92. Those having ordinary skill in the art would readily recognize that other chamber control subroutines can be included depending on what processes are desired to be performed in the process chambers 12a-c, 14, 16, 18. In operation, the chamber manager subroutine 90 selectively schedules or calls the process component subroutines in accordance with the particular process set being executed. Typically, the chamber manager subroutine 90 includes steps of monitoring the various chamber components, determining which components needs to be operated based on the process parameters for the process set to be executed and causing execution of a chamber component subroutine responsive to the monitoring and determining steps.

The reactant gas control subroutine 92 has program code for controlling reactant gas composition and flow rates. The reactant gas control subroutine 92 controls the open/close position of the safety shut-off valves, and also ramps up/down the mass flow controller to obtain the desired gas flow rate. The reactant gas control subroutine 92 is invoked by the chamber manager subroutine 90, as are all chamber component subroutines and receives from the chamber manager subroutine process parameters related to the desired gas flow rates. Typically, the reactant gas control subroutine 92 operates by opening the gas supply lines, and repeatedly (i) reading the necessary mass flow controllers, (ii) comparing the readings to the desired flow rates received from the chamber manager subroutine 90, and (iii) adjusting the flow rates of the gas supply lines as necessary. Furthermore, the reactant gas control subroutine 92 includes steps for monitoring the gas flow rates for unsafe rates, and activating the safety shut-off valves when an unsafe condition is detected.

The pressure control subroutine 94 comprises program code for controlling the pressure in chamber(s) 12a-c, 14, 16, and/or 18 by regulating the size of the opening of the throttle valve which is set to control the chamber pressure to the desired level in relation to the total process gas flow, size of the process chamber, and pumping set point pressure for the exhaust system. When the pressure control subroutine 94 operates to measure the pressure in chamber(s) 12a-c, 14, 16, and/or 18 by reading one or more conventional pressure nanometers connected to the chamber(s), compare the measure value(s) to the target pressure, obtain PID (proportional, integral, and differential) values from a stored pressure table corresponding to the target pressure, and adjust the throttle valve(s) according to the PID values obtained from the pressure table. Alternatively, the pressure control subroutine 94 can be written to open or close the throttle valve to a particular opening size to regulate the chamber(s) 12a-c, 14, 16, and/or 18 to the desired pressure.

The lamp control subroutine 96 comprises program code for controlling the power provided to lamps in chambers 12a-c and 14 which are used to heat the substrate 50. The lamp control subroutine 96 is also invoked by the temperature parameter. The lamp control subroutine 96 measures the temperature by measuring voltage output of the temperature measurement devices directed at the susceptor and (item 28 in FIG. 1B) compares the measured temperature to the setpoint temperature, and increases or decreases power applied to the lamps to obtain the setpoint temperature.

Applicants have stored in a program, code of the process of forming in situ stabilized high concentration borophosphosilicate glass films. The computer-readable program includes instructions to control a gas delivery system to introduce a reactant gas mix that includes a silicon source gas, a boron source gas, a phosphorous source gas and a carrier gas into a chamber to form a high concentration borophosphosilicate glass layer over a substrate positioned in the chamber. The computer-readable program further includes instructions to control a reflow temperature and ambient of the formed high concentration borophosphosilicate glass layer to fill at least one trench in the substrate.

Method for Forming in situ Stabilized High Concentration Borophosphosilicate Glass (BPSG) Films

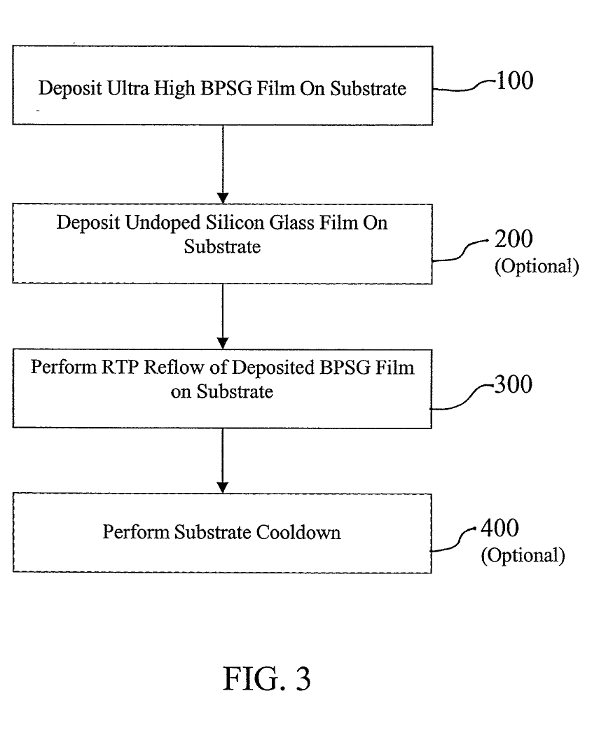

FIG. 3 outlines an embodiment of a method for forming in situ stabilized high concentration borophosphosilicate glass (BPSG) films on a semiconductor wafer according to the present invention. The method is generally carried out in multiple steps, integrated into several major process steps. The method generally includes depositing a dielectric film, such as a high concentration borophosphosilicate glass (BPSG) film, on a substrate by sub-atmospheric chemical vapor deposition (SACVD) (step 100 in FIG. 3). The method may optionally include depositing a capping layer of undoped silicon glass (USG) over the BPSG film (step 200 in FIG. 3). Next, the method includes rapid thermal processing (RTP) the deposited BPSG film layer by rapid heating the substrate to a reflow temperature greater than about 600° C. (step 300 in FIG. 3). The substrate may be rapid heated for a variety of purposes, such as performing reflow of deposited dielectric layers for planarization and/or gap-filling substrate trenches with high aspect ratios, or for driving in dopants redistribution to form uniform dopant concentration through film layers or just densify BPSG film. Following RTP, the substrate may be cooldown for a predetermined period of time prior to being removed from the multichamber system 10 (step 400 in FIG. 3).

In a preferred embodiment, the process may be carried in multiple steps, for example, first depositing a high concentration BPSG film onto a substrate/wafer at a deposition temperature less than about 600° C. and then rapid heating the wafer having the BPSG film thereon to a reflow temperature preferably above about 600° C.

BPSG Film Deposition

With reference to FIGS. 1A and 3, as part of step 100, a high concentration BPSG film is deposited on a substrate by chemical vapor deposition (CVD) in the multichamber system 10 having a pressure of about 60-750 torr. The high concentration BPSG film is deposited onto the substrate at temperatures greater than about 300° C. and preferably about 480° C. by introducing a phosphorus-containing source and a boron-containing source into one of the chambers, e.g. chamber 12a-c, of the multichamber system 10 along with the silicon- and oxygen-containing sources typically required to form a silicon oxide layer.

As a silicon source, the method of this invention preferably employs tetraethylorthosilicate (TEOS), however, other silicon-containing sources may be practiced within the scope of this invention. Examples of oxygen-containing sources that may be practiced within the scope of this invention include ozone (O₃) and oxygen (O₂). Examples of boron-containing sources that may be practiced with the method of this invention include triethylborate (TEB), trimethylborate (TMB), and similar compounds. Examples of phosphorus-containing sources that may be practiced with the method of this invention include triethylphosphate (TEPO), triethylphosphite (TEPᵢ), trimethylphosphate (TMOP), trimethylphosphite (TMPᵢ), and similar compounds. In a preferred embodiment, the method employs triethylborate (TEB) as a boron source and triethylphosphate (TEPO) as a phosphorous source.

With reference to FIGS. 1B and 3, the exemplary BPSG film/layer is deposited by heating a semiconductor wafer/substrate 50 and heater 28 within chamber 22 to a temperature in a range of about 300-600° C., preferably to about 480° C., and maintaining this temperature range throughout the deposition. Chamber 22 is maintained at a pressure within a range of about 60-750 torr, preferably in a range of about 150-250 torr, and more preferably at about 200 torr. Heater 28 is positioned about 50-400 mil from gas distribution plate 26 and is preferably positioned about 200 mil from plate 26.

It should be noted that the process parameters and values presented in the detailed discussion below is generally applicable to a SACVD chamber 22 having a volume of about 2 liters. Those skilled in the art to which this invention pertains will recognize that these process parameters and values may have to modified to properly account for other chamber capacities (i.e., volumes), process configurations and chamber system/chamber arrangements specific to a particular manufacturer, and other variables.

A process gas including TEB as the source of boron, TEPO as the source of phosphorus, TEOS as the source of silicon, and O₃ as a gaseous source of oxygen is formed. Being liquids, the TEB, TEPO and TEOS sources are vaporized by the liquid injection system 44 and then combined with an inert carrier gas, such as helium, in gas mixing block (or gas mixing box) 42. As stated above, it is recognized that other sources of boron, phosphorus, silicon, and oxygen also may be used. For a 200 mm system, the flow rate of TEB is preferably in a range of approximately 100-300 milligrams per minute (mgm), and preferably about 190 mgm. The flow rate of TEPO is in a range of approximately 10-150 mgm, preferably about 90 mgm, depending on the desired dopant concentration, while the TEOS flow rate is in a range of approximately 200-1000 mgm, preferably about 600 mgm. The vaporized TEOS, TEB, and TEPO gases then are mixed with a helium carrier gas flowing at a rate in a range of approximately 2000-8000 standard cubic centimeters (sccm), preferably at a rate of about 6000 sccm. Oxygen in the form of O₃ is introduced at a flow rate in a range of approximately 2000-6000 sccm and is preferably introduced at a flow rate of about 4000 sccm. The ozone mixture contains between about 5-20 weight percent (wt %) oxygen. The gas mixture is introduced into chamber 22 from gas distribution plate 26 to supply reactive gases to the substrate surface 50 where heat-induced chemical reactions take place to produce the desired film.

The above conditions result in a high concentration BPSG film deposited at a rate of between 2000-6000 Angstroms per minute (A/min). By controlling the deposition time, the thickness of the BPSG film deposited may thus be easily controlled. The resulting high concentration BPSG film has a boron concentration level in a range of approximately 2-7 wt % and a phosphorus concentration level in a range of approximately 2-9 wt % for a combined total weight percent of boron and phosphorous concentrations in the BPSG film/layer of about 10-12 wt %. In an embodiment, the resulting BPSG film has a boron concentration level of about 3 wt % and a phosphorus concentration level of about 9 wt %.

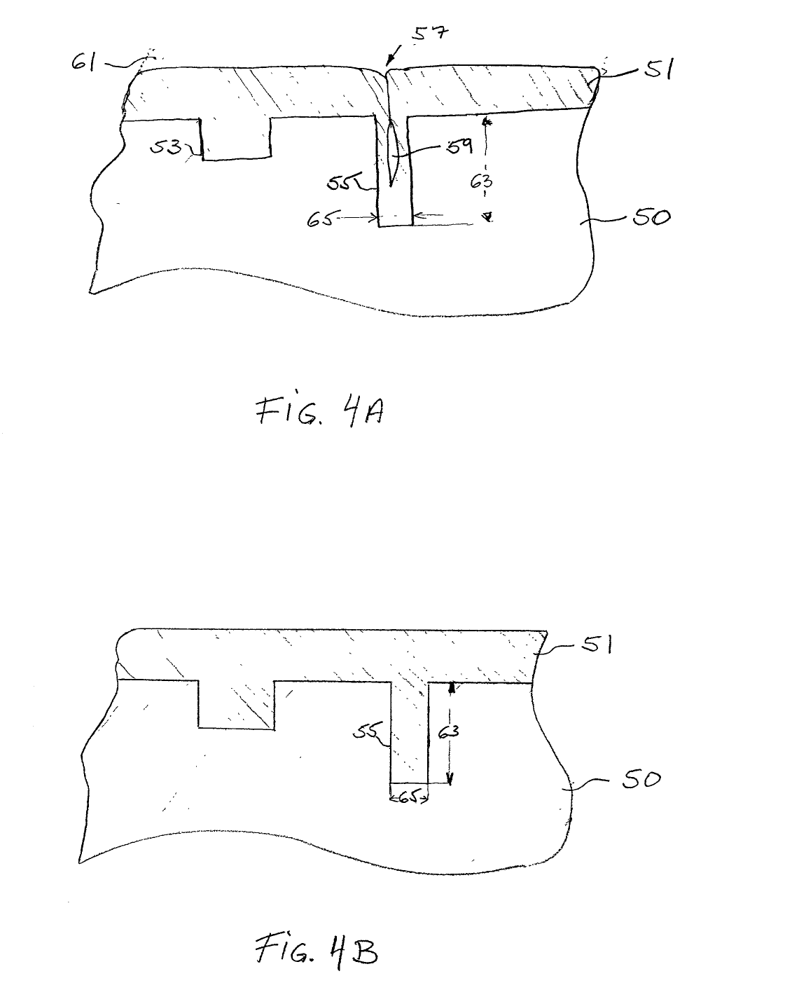

FIG. 4A is a simplified, cross-sectional view of a substrate 50 at an intermediate stage of the fabrication (step 200 of FIG. 3). FIG. 4A shows substrate 50 after the BPSG layer 51 has been deposited over the substrate's surface. As shown in FIG. 4A, at this stage of fabrication, substrate 50 may include at least one gap or trench area 53, 55 formed during a processing step prior to the deposition of the BPSG layer/film 51. After the deposition of the BPSG layer/film 51, the wide, shallow gap or trench 53 may be fully filled by the BPSG film 51. However, narrow gap/trench 55, having a high aspect ratio (i.e., height 63/width 65, as shown in FIG. 4A) may only be partially filled with the BPSG film 51 because the layer 51 has been pinched off in area 57 leaving behind void 59. Voids 59 in the substrate 50 are unacceptable for fabrication of reliable integrated circuits, therefore voids 59 are eliminated during the reflow stage (step 300 of FIG. 3) of the method of this invention.

With reference to FIGS. 3 and 4A, the deposited high concentration BPSG layer 51 may optionally be capped with a thin, separate undoped silicon glass (USG) layer 61 (step 200 in FIG. 3). The USG capping layer 61 prevents surface hydrolysis of highly doped BPSG layer.

The USG layer 61 can be deposited in a separate processing chamber from the BPSG layer 51, but preferably is done as an in situ process in chamber 12a-c where deposition of the BPSG layer 51 also occurred. According to an embodiment of the present invention, as part of optional step 200 of the method of this invention, an in situ USG or similar cap layer 61 is formed on a doped dielectric film, e.g., BPSG film, in SACVD chamber 12a-c by turning off the boron source and the phosphorus source just before completion of deposition of the BPSG layer. In this embodiment, the initial BPSG layer 51 is formed as described above. Flow of the TEB and TEPO dopant sources into vacuum chamber 22 then is stopped while the thermal reaction of TEOS and O₃ continues for an additional period of time, generally in a range of approximately 1-60 seconds. Preferably, the thermal reaction continues for about 3-10 seconds.

The USG cap layer 61 formed may have a thickness in a range of approximately 50-500 Å, and preferably in a range of approximately 100-200 Å. A person of ordinary skill in the art, however, will realize that capping layers of different thickness can be employed depending on the specific application and device geometry size.

Performing BPSG Reflow

With reference to FIGS. 1C, 3 and 4A, the third major process block (block 300 in FIG. 3) includes heating the substrate 50 having the high concentration BPSG film 51 deposited thereon (together with the USG film 61, if one has been deposited on substrate 50) to a temperature greater than about 600° C. The substrate 50 may be heated for a variety of purposes, such as performing reflow of deposited dielectric layers for planarization and/or gap-filling trenches with high aspect ratios, such as trench 55 in FIG. 4A (and thus eliminating voids 59), or for driving in dopants from the deposited doped dielectric layer.

Such heating can be performed using either a rapid thermal processing (RTP) method or conventional furnace, for example, and can be performed in a dry (e.g., N₂ or O₂) ambient, a wet (e.g., steam, H₂O) ambient, a wet ambient formed by insitu reaction of H₂ and O₂, or a combination thereof (ex-situ). In a preferred embodiment, step 300 of FIG. 3 is performed using an RTP approach performed in a wet ambient formed by in-situ reaction of H₂ and O₂.

In an embodiment of the method of this invention, the RTP reflow step 300 may start by loading the substrate 50 having a high concentration BPSG film 51 thereon into RTP chamber 14 of multichamber system 10 or into another type of substrate processing chamber in which the substrate can be heated. During the substrate loading process, oxygen from oxygen source 78 is flowed into RTP chamber 14 creating an oxygen ambient in chamber 14. The temperature of the RTP chamber 14 is initially set generally in a range of approximately 300° C. to 650° C. The loading temperature is set below 700° C. to minimize BPSG film 51 densification prior to the formation of the steam ambient.

After a predetermined period of time after the substrate 50 has been loaded into RTP chamber 14, generally in a range of approximately 30 seconds to 3 minutes, hydrogen from hydrogen source 76 is flowed into RTP chamber 14 to provide a steam (H₂/O₂) ambient. The temperature of chamber 14 is then increased from its initial setting to a second temperature above the reflow temperature of BPSG layer 51 with the optimum rate being decided based on the reflow temperature used, throughput issues and the susceptibility of the wafer to cracking among other things. The reflow temperature is generally set in a range of approximately 600-1050° C. In an embodiment, the reflow temperature is set in a range of approximately 600-850° C., and preferably slightly above about 700° C. In a preferred embodiment, this temperature increase occurs at a rate ranging from 20 to 40° C. per second until the desired temperature is reached and a BPSG film/layer can be flowed up to about 5 minutes. The actual time for this sub-step depends on the initial temperature setting of RTP chamber 14, the temperature selected to reflow layer 51, the glass transition temperature of layer 51 and the temperature ramping rate, among other factors.

It will be noted that the glass transition temperature of a given BPSG film layer, such as film layer 51, depends on the boron and phosphorus dopant concentrations of the layer as is understood by persons of ordinary skill in the art. Increasing the boron concentration of the BPSG layer is the most significant factor in reducing the reflow temperature of the layer. The high concentration BPSG film of this invention has a boron concentration in a range of approximately 2-7 wt %, a phosphorus concentration in a range of approximately 2-9 wt %, and a combined dopant concentration (boron and phosphorus) of about 10-12 wt %.

Once the reflow temperate is reached, substrate 50 is kept in RTP chamber 14 in order to reflow and thus planarize BPSG film layer 51. The reflow process is generally done at atmospheric or higher pressure, except in in-situ steam generation where a low pressure, e.g. less than 20 torr, is applied to ensure safe operation, such that the BPSG film layer flows and material from the walls of trench 55 is drawn into the void(s) 59 by the flow. Generally, the reflow step (step 300 in FIG. 3) lasts for a time in a range of approximately 5 seconds to 5 minutes depending on the temperature used to reflow the layer and the desired degree of planarization.

Alternatively, in another embodiment, prior to unloading substrate 50 from the RTP chamber 14, the oxygen flow is continued while the hydrogen flow is stopped in order to anneal layer BPSG film layer 51 in an oxygen only ambient. This step, generally referred to as a “dry anneal” step, helps minimize the hydrogen and moisture content inside of layer 51. Preferably, the dry anneal step lasts for approximately 2 and 10 seconds.

FIG. 4B is a simplified, cross-sectional view of substrate 50 with the BPSG film 51 deposited thereon following the reflow step 300 of the method of this invention. Note that optional USG film layer 61 shown in FIG. 4A is not illustrated in FIG. 4B. As shown in FIG. 4B, according to the method of this invention, reflow of deposited BPSG film layer 51 causes the planarization of BPSG film 51 as well as filling of the high aspect ratio trench 55, thus eliminating void 59 (shown in FIG. 4A).

After BPSG layer 51 is annealed or flowed, the RTP chamber temperature is reduced and substrate 50 may be subjected to a cooldown step (step 400 in FIG. 3). In an embodiment, cooldown step 400 may be performed in chamber 16 of multichamber system 10 (shown in FIG. 1A) under vacuum conditions. The cooldown step 400 may last from as low as several minutes to several hours or days. Alternatively, the cooldown step 400 may be performed by removing substrate 50 from the multichamber system 10 and placing it in a separate storage area/chamber (not shown) where it will be stored until ready to be used in IC manufacture.

Depositing and reflowing a high concentration BPSG layer 51 according to the method of the present invention is anticipated to completely fill narrow gap or trenches, such as trench 55 in FIGS. 4A-4B, having an aspect ratio in a range of approximately 7:1 to 10:1, and a trench width as small as 0.02 microns.

Thus, a method and apparatus for forming in situ stabilized high concentration borophosphosilicate glass (BPSG) films on a semiconductor wafer has been described. Although specific embodiments, including specific equipment, parameters, methods, and materials have been described, various modifications to the disclosed embodiments will be apparent to one of ordinary skill in the art upon reading this disclosure. Therefore, it is to be understood that such embodiments are merely illustrative of and not restrictive on the broad invention and that this invention is not limited to the specific embodiments shown and described.

We claim:

1. A method of forming a high concentration borophosphosilicate glass layer on a substrate, the method comprising:
providing a substrate in a chamber;
providing a silicon source, a oxygen source, a boron source and a phosphorous source into the chamber to form a high concentration borophosphosilicate glass layer on the substrate; and
reflowing the high concentration borophosphosilicate glass layer formed on the substrate.

2. The method of claim 1 further comprising cooling the substrate for a predetermined period of time following reflowing the high concentration borophosphosilicate glass layer formed on the substrate.

3. The method of claim 1 wherein the high concentration borophosphosilicate glass layer comprises about 2-7 weight percent boron and about 2-9 weight percent of phosphorous.

4. The method of claim 1 wherein a combined weight percent of boron and phosphorous present in the high concentration borophosphosilicate glass layer is about 10-12 weight percent.

5. The method of claim 1 wherein providing the silicon, oxygen, boron and phosphorous sources into the chamber to form the high concentration borophosphosilicate glass layer on the substrate is performed at a deposition temperature in a range of approximately 300-600° C.

6. The method of claim 1 wherein reflowing the high concentration borophosphosilicate glass layer is performed at a reflow temperature in a range of approximately 600-1050° C. in an ambient selected from the group consisting of dry ambient, steam ambient, water ambient and ambient formed by in-situ reaction of H₂ and O₂.

7. The method of claim 1 wherein the silicon source is TEOS.

8. The method of claim 1 wherein the oxygen source is O₃.

9. The method of claim 1 wherein the boron source comprises TEB.

10. The method of claim 1 wherein the phosphorous source comprises TEPO.

11. The method of claim 1 wherein the high concentration borophosphosilicate glass layer fills at least one trench contained in the substrate having an aspect ratio of about 7:1 to 10:1.

12. A method of forming an insulating layer on a substrate, the method comprising:
providing a substrate in a chamber;
providing a silicon source, a oxygen source, a boron source and a phosphorous source to chemical vapor deposit a high concentration borophosphosilicate glass layer on the substrate;
forming a second insulating glass layer of undoped silicon glass over the high concentration borophosphosilicate glass layer; and
reflowing the deposited high concentration borophosphosilicate glass layer on the substrate.

13. The method of claim 12 wherein the high concentration borophosphosilicate glass layer comprises about 2-7 weight percent boron and about 2-9 weight percent of phosphorous.

14. The method of claim 12 wherein a combined weight percent of boron and phosphorous present in the high concentration borophosphosilicate glass layer is about 10-12 weight percent.

15. The method of claim 12 wherein reflowing the high concentration borophosphosilicate glass layer is performed at a reflow temperature in a range of approximately 600-1050° C. in an ambient selected from the group consisting of dry ambient, steam ambient, water ambient and ambient formed by in-situ reaction of H₂ and O₂.

16. The method of claim 1 -wherein the silicon source is TEOS flowing in the chamber at a rate of about 200-1000 milligrams per minute.

17. The method of claim 1 wherein the boron source is TEB flowing in the chamber at a rate of about 100-300 milligrams per minute.

18. The method of claim 1 wherein the phosphorous source is TEPO flowing in the chamber at a rate of about 10-150 milligrams per minute.

19. The method of claim 1 wherein the oxygen source is O₃ flowing in the chamber at a rate of about 2000-6000 standard cubic centimeters per minute.

20. The method of claim 1 wherein the high concentration borophosphosilicate glass layer is formed in the chamber at a rate in a range of approximately 2000 to 6000 Å/min.

21. The method of claim 12 wherein the second insulating glass layer has a thickness in a range of approximately 100 to 200 Å.

22. A method of depositing an insulating layer on a substrate having at least one trench, the method comprising:
chemical vapor depositing a high concentration borophosphosilicate glass layer over the substrate by providing TEOS, O₃, TEB and TEPO into a chamber at a deposition temperature of about 300° C. to 600° C. and a sub-atmospheric pressure of about 60 to 750 torr, the high concentration borophosphosilicate glass layer comprising less than or equal to about 7.0 weight percent boron and less than or equal to about 9.0 weight percent of phosphorous for a combined boron and phosphorous concentration of about 10-12 weight percent; and
reflowing the deposited high concentration borophosphosilicate glass layer at a reflow temperature in a range of approximately 600° C. to 1050° C. to fill the at least one trench in the substrate with the high concentration borophosphosilicate glass layer.

23. The method of claim 22 wherein the at least one trench has a high aspect ratio of about 4:1 to 10:1.

24. A substrate processing system comprising:
a substrate holder located within a chamber;
a gas delivery system to introduce a reactant gas mix into the chamber to deposit an insulating layer over the substrate;
a pump coupled to a gas outlet to control the chamber pressure;
a rapid thermal anneal system to reflow the layer deposited over the substrate;
a controller to control the gas delivery system and the pump, the controller further to control the rapid thermal anneal system; and
a memory coupled to the controller comprising a computer-readable medium having a computer-readable program embodied therein to direct operation of the substrate processing system, the computer-readable program comprising:
instructions to control the gas delivery system to introduce a reactant gas mix including a silicon source gas, a boron source gas, a phosphorous source gas and a carrier gas into the chamber to deposit a high concentration borophosphosilicate glass layer over the substrate positioned on the substrate holder, the instructions further to control a temperature of the reflow to enable the deposited high concentration borophosphosilicate glass layer to fill a trench in the substrate.

25. The substrate processing system of claim 24 wherein the high concentration borophosphosilicate glass layer has a boron concentration in a range of approximately 2-7 weight percent and a phosphorus concentration in a range of approximately 2-9 weight percent for a combined boron and phosphorous concentration of about 10-12 weight percent.

26. The substrate processing system of claim 24 wherein the reflow is performed at a reflow temperature in a range of approximately 600-1050° C. in an ambient selected from the group consisting of dry ambient, steam ambient, water ambient and ambient formed by in-situ reaction of H₂ and O₂.

27. The substrate processing system of claim 24 wherein the trench has a high aspect ratio of about 4:1 to 10:1.
